(19) United States
(12) Patent Application Publication
(10) Pub. No.: US 2026/0060163 A1
(43) Pub. Date: Mar. 5, 2026

(54) GAUGE WHEEL

(71) Applicant: SCHAFFERT MANUFACTURING COMPANY, INC., Indianola, NE (US)

(72) Inventor: Paul E. SCHAFFERT, Indianola, NE (US)

(21) Appl. No.: 19/315,050

(22) Filed: Aug. 29, 2025

Related U.S. Application Data
(60) Provisional application No. 63/688,684, filed on Aug. 29, 2024.

(51) Int. Cl. A01C 5/06; A01C 7/20

(52) U.S. Cl. CPC A01C 5/064; A01C 5/068; A01C 7/203

(57) ABSTRACT

A gauge wheel coupled to a trailing arm assembly of a planter, the gauge wheel including a hub rotatable about an axis of rotation, a rim coupled to the hub and including a perimeter edge, the rim having a first side and second side opposite the first side, a first plurality of tread portions extending from the first side and positioned radially inward from the perimeter edge, and a second plurality of tread portions extending from the second side and positioned radially inward from the perimeter edge.

### CROSS-REFERENCE TO RELATED APPLICATIONS

This application claims the benefit of priority pursuant to 35 U.S. C. § 119(e) of U.S.

Provisional Ser. No. 63/688,684 , filed Aug. 29, 2024, titled “GAUGE WHEEL,” which is hereby incorporated by reference herein in its entirety for all purposes.

### FIELD

The described embodiments of the present disclosure relate to trailing arm assemblies of agricultural planters. Specifically, the described embodiments of the present disclosure relate to gauge wheels of trailing arm assemblies.

### BACKGROUND

Agricultural seed planting is typically accomplished by multi-row planters. Each planter may include multiple row units adapted for clearing debris on the field surface, opening a seed furrow, depositing seeds within the furrow, and closing the seed furrow around the seeds.

The row units often include opener assemblies to open the seed furrows. The row units may include gauge wheels that roll over and contact a top surface of the soil adjacent the opening assemblies, which opening assemblies displace the soil to open a furrow. The gauge wheel uses the surface of the field as a reference to set the depth of the adjacent opener disc. However, debris on top of, or at least partially within soil may interfere with a typical gauge wheel and prevent the gauge wheel from maintaining contact with the surface of the field, and thus cause the furrow depth to vary. For example, rolling over the debris that deflects the gauge wheel upward causes the furrow opener to lift upwardly also, thus making the furrow less deep than desired. Further, conventional gauge wheels may be negatively affected by moist or wet soil, or other debris that may stick to a conventional gauge wheel. Accordingly, wet soil and debris on the gauge wheel and opener disc may negatively affect the furrow depth, consistency, and geometry, leading to poor planting and growing conditions for seeds placed into the furrows. Thus, there is a need in the art for a planter and gauge wheel capable of consistent heights in the presence of debris or wet soil.

### SUMMARY

Embodiments of the present invention are directed to a gauge wheel having a tread on either side or a central disc that extends radially beyond the treads.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combination of the first aspect.

In one example, the invention includes a gauge wheel for coupling to a trailing arm assembly of a planter, the gauge wheel comprising a hub rotatable about an axis of rotation, a rim coupled to the hub and including a perimeter edge, the rim having a first side and second side opposite the first side, a first plurality of tread portions extending from the first side and positioned radially inward from the perimeter edge, and a second plurality of tread portions extending from the second side and positioned radially inward from the perimeter edge.

In some examples, the first plurality of tread portions and the second plurality of tread portions are annularly aligned with each other relative to the axis of rotation.

In some examples, the first plurality of tread portions are annularly spaced about the first side. In some examples, the first plurality of tread portions define voids between adjacent tread portions of the first plurality of tread portions.

In some examples, the first plurality of tread portions may include a tine extending from the first side in a direction that includes a directional component in one or more of a radial direction, an axial direction, or a tangential direction.

In some examples, each tread portion of the second plurality of tread portions include a tine extending from the first side in a direction that includes a directional component in one or more of a radial direction, the axial direction, or the tangential direction.

In some examples, the first distance between the perimeter edge and the first plurality of tread portions may be less than a second distance between the perimeter edge and the axis of rotation. Alternatively, the first distance between the perimeter edge and the first plurality of tread portions is greater than a second distance between the perimeter edge and the axis of rotation.

In some examples, the rim may define a periphery radially outward from the axis of rotation, the periphery including the perimeter edge and the periphery narrows in a radial direction to the perimeter edge.

In another example, an agricultural wheel may be coupled to a trailing arm assembly of a planter, the agricultural wheel comprising a hub rotatable about an axis of rotation, a rim extending radially from the hub and defining a perimeter, the rim having a first side and second side opposite the first side, and an outer rim assembly coupled to at least one of the first side or the second side and defining a radial outer portion, the outer rim assembly including a plurality of tread portions annularly spaced about the radial outer portion, wherein the rim extends radially outward beyond the plurality of tread portions, and the agricultural wheel is configured to define a position of one or more components of the trailing arm assembly relative to a field surface.

In some examples, the plurality of tread portions are a first plurality of tread portions, and the outer rim assembly comprises a first outer rim coupled to the first side and including the first plurality of tread portions, and a second outer rim coupled to the second side and including a second plurality of tread portions.

In some examples, the first plurality of tread portions extend axially in a first direction away from the rim, and the second plurality of tread portions extend axially a second direction away from the rim.

In some examples, the first plurality of tread portions and the second plurality of tread portions are annularly spaced about the axis of rotation.

In some examples, the first plurality of tread portions and the second plurality of tread portions are aligned with one another.

In some examples, the plurality of tread portions define voids between annularly adjacent tread portions.

In some examples, the plurality of tread portions define a peripheral surface area, the perimeter defines a central surface area along the perimeter, and the peripheral surface area is greater than the central surface area.

In some examples, the rim defines a major plane orthogonal to the axis of rotation, and the agricultural wheel is symmetrical about to the major plane.

In another example, a gauge wheel comprises a hub rotatable about an axis of rotation, a rim extending radially from the axis and defining a perimeter positioned radially outward from the hub and extending annularly about the axis of rotation, and a plurality of tread portions annularly spaced about the axis of rotation and positioned radially inward from the perimeter, wherein during use the plurality of tread portions are configured to be positioned on, adjacent, or above a top surface of a field and the perimeter is configured to be positioned at least partially below the top surface.

In some examples, the outer rim assembly includes a first outer rim coupled to a first side of the rim; and a second outer rim coupled to a second side of the rim opposite the first side.

In some examples, the outer rim assembly include the plurality of tread portions.

In some examples, the plurality of tread portions are integrally formed with at least one of the first outer rim or the second outer rim.

In some examples, the plurality of tread portions are separate from and connected to the outer rim assembly.

In some examples, the plurality of tread portions are connected to the rim.

In some examples, the plurality of tread portions are integrally formed with the rim.

In some examples, the rim has an axial width and a diameter; and the axial width is substantially less than the diameter.

In some examples, the rim has an axial width, a tread portion of the plurality of tread portions have a tread width and the tread width is greater than or equal to the axial width.

In some examples, the plurality of tread portions are annularly spaced by an annular distance, each tread portion of the plurality of tread portions have a tread width, and the annular distance is greater than the tread width.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts side view of an agricultural tractor and an agricultural planter;

FIG. 2 depicts a top-rear perspective view of the agricultural tractor and agricultural planter of FIG. 1, with a generic gauge wheel;

FIG. 3 depicts a side elevation view of a trailing arm assembly including the gauge wheel described herein;

FIG. 4 depicts a perspective view of the example gauge wheel;

FIG. 5 depicts an exploded view of the example gauge wheel of FIG. 4;

FIG. 6 depicts a front elevation view of the example gauge wheel of FIG. 4;

FIG. 7 depicts a side elevation view of the example gauge wheel of FIG. 4;

FIG. 8 depicts a rear elevation view of an example gauge wheel and opener feature during use.

### DETAILED DESCRIPTION

The description that follows includes sample systems, methods, and apparatuses that embody various elements of the present disclosure. However, it should be understood that the described disclosure may be practiced in a variety of forms in addition to those described herein.

The described embodiments of the present disclosure relate to trailing arm assemblies of agricultural planters. Specifically, the described embodiments of the present disclosure relate to gauge wheels of trailing arm assemblies of an agriculture planter.

The trailing arm assemblies may be a planter row unit and may include a furrow opener assembly opener assembly including an opener disc and a gauge wheel. The furrow opener assembly may be disposed behind the planter frame and the opener disc may open a furrow for depositing seed, fertilizer, or the like. The trailing arm assembly may include a furrow closer assembly secured behind the furrow opener assembly. The trailing arm assembly may include one or more linkages enabling vertical movement of different portions of the trailing arm assembly. In this way, the portions of the trailing arm assembly may translate vertically relative as the trailing assembly is moved forward over the field surface, which may have a varying topography.

During use of the trailing arm assembly, the gauge wheel rolls across a top surface of the field. The gauge wheel is connected to the trailing arm assembly such that the gauge wheel sets a height of the furrow opener assembly, and in some examples the trailing arm assembly, relative to the top surface. Accordingly, the gauge wheel may set a depth of the opener disc extending into the ground to form a furrow in the field, a corresponding height of a closer assembly. In this way, in at least one embodiment, the gauge wheel may function to set and maintain the depth of the furrow or positions of the other implements of the trailing arm assembly. Examples of the gauge wheel described herein may be configured to maintain consistent furrow depths and geometries in a variety of soil conditions.

The gauge wheel may include a hub which rotates about an axis, a rim extending generally radially from the axis, and a tread including a plurality of tread portions extending, at least in part, axially outward. For example, away from the rim. The hub may define or a receive a features, such as an axle, bearing, or bushing to enable rotation of the gauge wheel about the axis.

The center rim may be a circular plate, disc, or ring. The center rim has a comparatively thin axial width in comparison to a diameter of the rim. The center rim may define a peripheral portion radially spaced from the axis of rotation. The peripheral portion may define an outer edge. The outer edge may taper to a point, defined as a bladed edge, or otherwise have a relatively thin profile. The center rim may define a center plane defined as perpendicular to the axis and bisecting the rim. The perimeter edge portion may define a radially outermost edge of the rim and include the surrounding periphery. In some examples, the perimeter edge portion is shaped to define a bladed edge, a toothed edge, or the like.

The gauge wheel includes a tread. The tread includes a plurality of tread portions. The plurality of tread portions may be tines, rods, beams, or other axially extending features positioned annularly about the axis of rotation. The tread portions may be spaced such that a plurality of voids or gaps are defined between the tread portions. The tread portions may extend outward from one or both sides of the gauge wheel. In some examples, the tread includes one or more tread caps connectable to side of the center rim and including the tread portions. The tread portions may extend from or be formed integrally with the tread caps. In other examples, the tread portions may extend from the center rim. The tread portions extend axially outward, at least in part, relative to the center rim. The tread portions may additionally extend transverse to a direction of rotation of the wheel or a radial direction.

When the gauge wheel is assembled, the periphery of the rim extends radially outward relative to and beyond the tread. The treads are positioned radially inward from the outer edge and extend axially outward from the rim. The treads are arranged on the exterior portion of the rim such that at least a portion of at least one tine on each side of the wheel may be in contact with the soil during rotation of the wheel.

During use, when pressing down on top or side of the closed furrow, the outer edge of the rim cuts into the soil. The pressure of the gauge wheel and the thinner profile may break through or cut debris encountered by the rim. The tread stay on top of the soil. For example, as the gauge wheel rotates, the treads contact the soil adjacent the rim and over a surface area sufficient to maintain the tread portions above the soil. The voids between the tread portions enable the passage of field debris (rocks, plant matter, or the like) through the tread. As a result, the perimeter edge of the rim and the tread act to break through or avoid debris, thereby limiting deflection of the gauge wheel to maintain a consistent depth.

Further, the varied topography of the tread discourages wet or moist soil from sticking and accumulating on the gauge wheel. That is, the voids between the tread portions and the varied topography of the surface of the gauge wheel formed by the tread portions tend to form discrete clumps or sections of soil sticking to the surface. These discrete sections are more likely to fall off the surface of the gauge wheel before further layers of soil and debris build up on existing soil stuck to the wheel.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

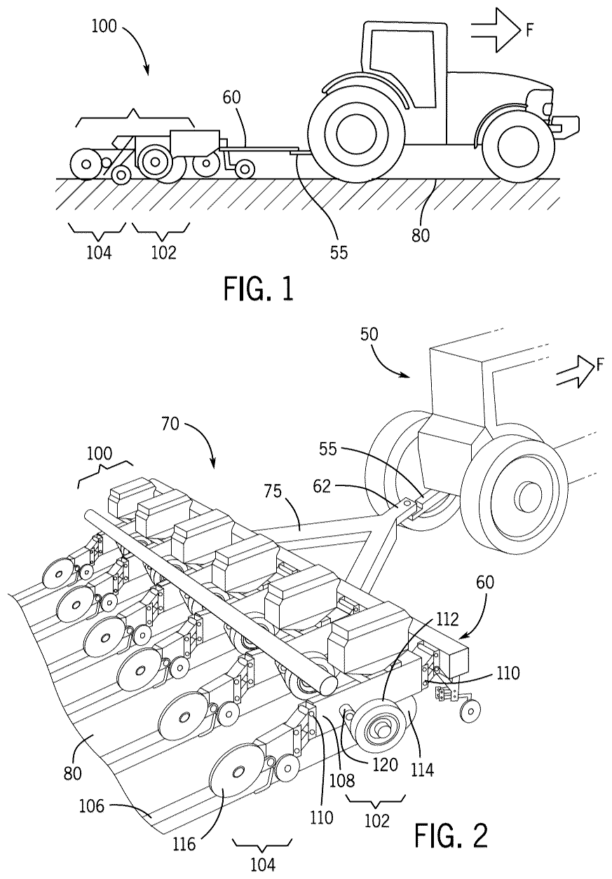

An exemplary embodiment of an agriculture planter 70 having one or more trailing arm assemblies 100 attached to an agricultural tractor 50 is shown in FIGS. 1 and 2. The linkage assemblies of the present disclosure may be used with the agriculture planter 70 and/or trailing arm assemblies 100, as described herein below. For purposes of illustration, the agricultural tractor 50 may have a hitch or another receiver 55 extending rearward therefrom. As illustrated in FIG. 2, the planter 70 may include a tool bar 75 from which a yoke or frame 60 with a tongue or hitch 72 extends in a forward direction F. The hitch 72 connects with the hitch receiver 55 to couple the planter 70 to the tractor 50. Various planter components are supported on the tool bar 75 and extend therefrom in a rearward direction (opposite the forward direction F). The tractor 50 tows the planter 70 in the forward direction F indicated by the arrow and provides power to the planter 70 for powering the operations of the planter 70. Additional operations of the planter 70 may be powered by hydraulics or electrical motors (not shown) powered by the tractor 50.

Components of the planter 70 may include a plurality of trailing arm assemblies 100.

The trailing arm assemblies 100 may function as row units for planting seeds, distributing liquid fertilizer, or a variety of other crop planting and management tasks. Each trailing assembly 100 may be coupled with the tool bar 75 or yoke that extends from the front of the trailing assembly 100. Each trailing assembly 100 may be equipped with a furrow opener assembly 102. Each trailing assembly 100 may also be equipped with a trailing furrow closer assembly 104. As used herein, the term “row unit” may refer to a portion of the trailing assembly 100 configured to work along, such as open or close, a single furrow (e.g., furrow 106). For example, a row unit may include a single furrow opener assembly 102 coupled to and ahead of a single furrow closer assembly 104 to open and close, respectively, the same furrow 106.

In the exemplary embodiment shown, the furrow opener assembly 102 may include an opener assembly frame 108, which may be connected to the tool bar 75 via a linkage assemblies 110, such as in one example parallel linkages. The linkages 110 allows the furrow opener assembly 102 and the furrow closer assembly 104 to move/translate up and down vertically (generally orthogonal to forward direction F) to follow the terrain (e.g., contours of the field), overcome obstacles (e.g., debris or the like), or otherwise negotiate similar changes in a surface 80 of a field.

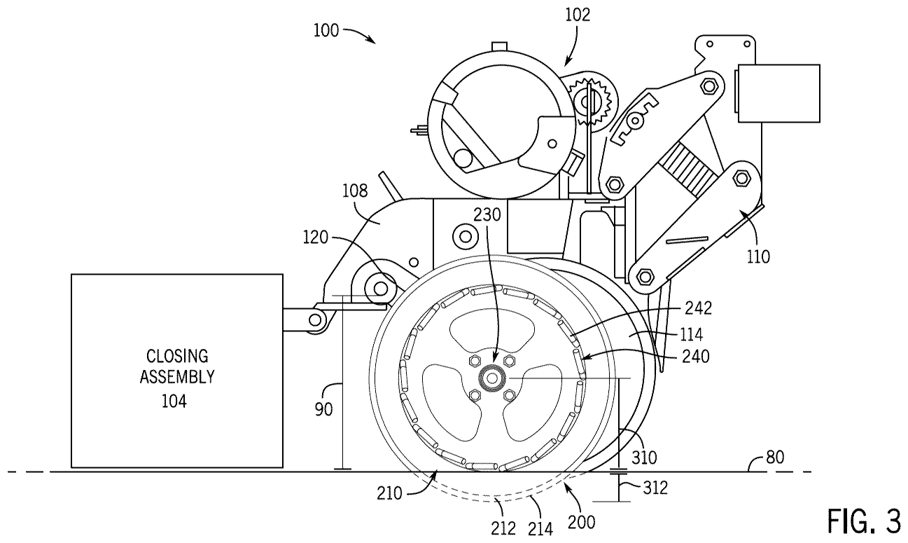

The furrow opener assembly 102 may include a gauge wheel 112. The gauge wheel 112 in FIG. 1 and FIG. 2 is depicted as a conventional gauge wheel, which often include a rubber tire as the radially exterior surface. The rubber tire is often prone to jump or deflect after contacting uneven terrain or debris. FIG. 3 depicts an example novel gauge wheel 200 as described herein. The furrow opener assembly 102 may additionally include an opener disc 114, or other components for opening a furrow 106. The opener disc 114 may also be referred to as an opener wheel. Each of the gauge wheel 112 and the opener disc 114 may be connected to the opener frame, or trailing arm assembly 100, by one or more arms or links 120.

The furrow closer assembly 104 may include one or more closer implements or wheels 116 to close the furrow 106. In some embodiments, the furrow closer assembly 104 may further include a separate fertilizer dispenser assembly. The vertical movement provided by the linkages 110 may allow the trailing arm assemblies 100 to follow or translate up and down as the gauge wheel 112 sets a height of the trailing arm assembly 100 relative to the field surface 80, allowing the opener discs 114 and closer wheels 116 to travel over or through a field surface 80.

As described herein, the novel gauge wheel 200 includes features to travel over or through debris and obstructions in a field surface 80 without adversely impacting seed deposit depth by maintaining consistent contact with the field surface 80, which may improve opening or closing of furrows 106. Similarly, a consistently opened furrow 106 may be more consistently closed by trailing furrow closer wheels 116.

FIG. 3 illustrates a side view of an example of the trailing arm assembly 100 including the novel gauge wheel 200. FIG. 3 depicts the furrow opener assembly 102, while the furrow closer assembly 104 is represented by the box 104. During use, the gauge wheel 200 is configured to roll across a top surface 80 of the field to define a position or height 90 of the opener assembly 102 relative to the surface 80 of the field. Accordingly, the gauge wheel 200 defines the position of the opener disc 114 relative to the field, and the depth the opener disc 114 or furrow 106 extends below or into the surface 80 of the field.

As described herein, the gauge wheel 200 is configured to roll over or press against the surface 80 as well as extend at least some distance into the surface 80 of the field. By rolling over and extending into the surface 80, the gauge wheel 200 maintains the opener frame 108 at a consistent height relative to the surface 80 and at a more consistent height when compared to convention gauge wheels that only roll over the surface 80. The opener disc 114 may be rotatably secured to the opener frame 108 such that a depth at which the opener disc 114 penetrates below the surface 80 to form a furrow 106 in the field 80 is also consistent. In this way, in at least one embodiment, the gauge wheel 200 may function to set and maintain the depth of the furrow 106, shown in FIG. 2, created by the furrow opener disc 114. In some examples, one or more arms 120 connecting the gauge wheel 200 or opener disc 114 to the opener frame 108 may be adjustably positioned relative to the frame 108 by hydraulics or electrical actuators or motors to adjust the height 90 of the opener frame 108, or a depth of the opener disc 114 relative to the gauge wheel 200.

By compensating for rough terrain, embodiments of the gauge wheel 200 shown in FIG. 3 and described herein maintain consistent furrow depths and geometries in a variety of soil conditions. For example, wet or moist soil may tend to stick to and build up on conventional wheels and the gauge wheels 200 described herein may be configured to limit such build up on the opener disc 114 during operation.

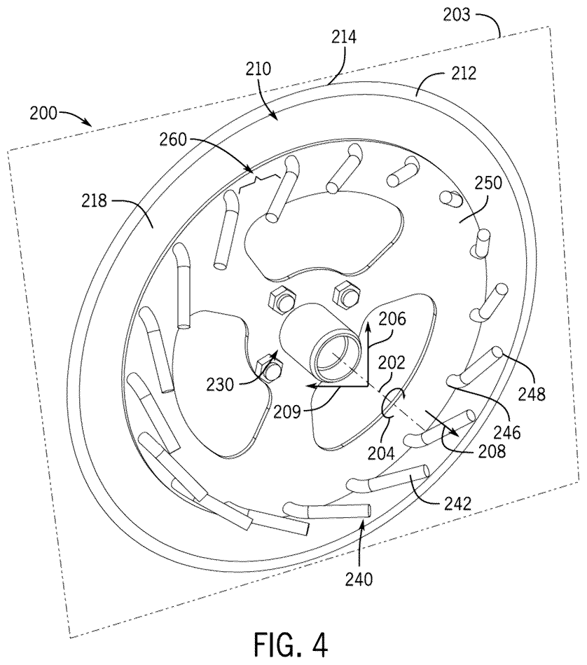

FIGS. 4-8 illustrate various views of the example gauge wheel 200. The gauge wheel 200 is rotatable about an axis of rotation 202 and may be configured to rotate in rotational direction 204, as indicated in FIG. 4. A radial direction 206 may be defined orthogonal to the axis of rotation 202. An axial direction 204 may be defined parallel to the axis of rotation 202. The gauge wheel 200 includes a rim 210 and a hub 230. The gauge wheel 200 includes a tread 240.

In accordance with various embodiments, the hub 230 may be or define a central aperture or structure of the wheel 200. The hub 230 may be defined by a cylindrical protrusion or feature. In some examples, the hub 230 is defined by or extends from the rim 210. The hub 230 may extend axially through the gauge wheel 200. In accordance with various embodiments, the hub 230 may be operable to receive a bearing. In some examples, the hub 230 may additionally or alternatively receive a central shaft, axle, bushing or the like from the trailing arm assembly 100. For example, the hub 230 may connect with or receive a feature of the arm 120 to connect the wheel 200 to the opener frame 108. In some examples, a cylindrical hub 230 may be operable to provide additional support to the bearing and/or a shaft by providing greater width to the gauge wheel 200 over an interface between the gauge wheel 200 and the arm 120. As a result, a greater downward force may be applied to the gauge wheel 200 to maintain contact with the soil 80. The hub 230 may be manufactured in accordance with any known process to form any known or developed structure of hub.

The rim 210 may be a circular feature such as a disc, plate, ring, or the like. The rim 210 may extend radially from or relative to the axis of rotation 202. In one example, the rim 210 may be formed from a portion of plate metal stamped or cut into a circular plate. The rim 210 includes axial sides 218, which may be a left or right side. In some examples, the rim 210 may be formed to include one or more spokes or define continuous exterior faces. The side wall 218 may include one or more apertures 226 that extend through sidewall 218. In some examples, the rim 210 includes a central aperture 224 corresponding the hub aperture 232.

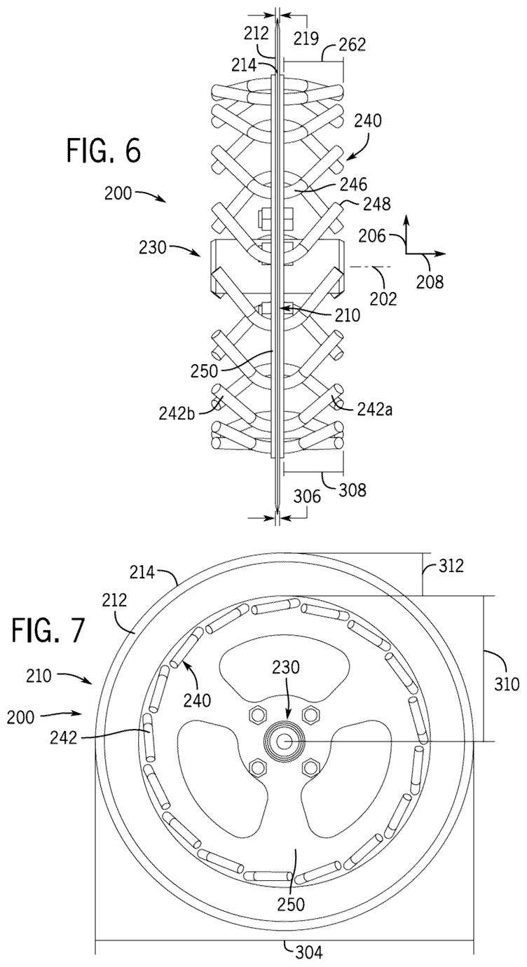

The rim 210 may extend outward to a peripheral region or portion 212. The peripheral portion 212 may include or define the perimeter of the rim 210 and the wheel 200. For example, the peripheral portion 212 may define the outer radial or perimeter edge 214 of the rim. The outer radial edge 214 may include a variety of profiles. For example, the peripheral portion 212 may be defined by a transition in the width, thickness, or orientation of the sidewalls 218 leading to the radial edge 214. The radial edge 214 may form a pointed or sharpened edge, as exemplified in FIG. 6. In other examples, the radial edge 214 may tapered, round, serrated, or the like.

The rim 210 has a diameter 304, shown in FIG. 7, and an axial thickness 306, shown in FIG. 6. The axial width 306 is substantially less than the diameter 304 such that the disc is relatively thin. As noted, the periphery 212, and in turn the radial edge 214, may be a thinner or pointed portion of the rim 210. Accordingly, he radial edge 214 may define a relatively small rim surface area 219.

The rim 210 may define a center plane 203. The center plane 203 may be defined as a plane perpendicular to the axis of rotation 202, or extending along the radial direction 206. The center plane 203 may generally bisect the rim 210. The center plane 203 may define the center of the wheel 200. While specific embodiments may be discussed herein, the rim 210 may not be so limited but may be manufactured in accordance with any process to form any rim structure.

In some examples, the rim 210 includes tread mounting features, not shown. The tread mounting features may be apertures formed though the rim 210, such as between the sidewalls 218. In some examples, the tread mounting features may be recesses defined in the sidewalls 218.

The wheel 200 includes a tread 240. The tread 240 defines a plurality of tread portions 242. In accordance with various embodiments, the tread portions 242 may be defined as one or more axially extending outward features (e.g., in direction 208). The tread portions 242 may be one or more of tines, rods, beams, or similar elongated features. The tread portions 242 may extend from an inner end 246 to an outer end 248. The axial distance from the inner end 246 to the outer end 248 may define a tread width 308. The tread portions 242 may be manufactured having the same diameter, width, or thickness from the inner end 246 to the outer end 248. In some embodiments, the tread portions 242 may not have a consistent diameter but may narrow or widen over the tread width 308, or have some other profile. In some examples, the tread 240 may be or referred to as an outer rim assembly.

The tread portions 242 may extend at least in the axial direction 208. For example, the tread portions 242 may be arranged such that the outer ends 248 are axially spaced from the inner ends 246 or the center plane 203. In some examples, the tread portion 242 may be described as having one or more of an axial component (e.g., in the axial direction 208), a radial component (e.g., in the radial direction 206), or a tangential component (e.g., parallel with center plane 203 or orthogonal to the radial direction 206 in a tangential direction 209). In some examples, the tread portion 242 may not have a radial component such that the tread 240 has a consistent outermost diameter. For example, one or both of the inner end 246 or the outer end 248 of each tread portion 242 may have a consistent distance relative to the axis of rotation 202.

The tread portions 242 may be planar, angled, or curved from the inner end 246 to the outer end 248. In some examples, each of the tread portions 242 may form a substantially planer structure when viewed along the axial direction 208 (e.g., along the center plane 203). The tread portions 242 may include a curve or angle in a direction orthogonal to the center plane 203. For example, by placing a bend in a length of the tread portion 242.

The tread portions 242 may extend in only one direction from the center plane 203, or they may extend in both directions from the center plane Y. For example, the tread 240 may include a first series of tread portions 242a for a first side of the wheel 200 and a second series of tread portions 242b opposite the first tread portions 242a on a second side of the wheel 200. In other examples, the tread portions 242 may extend through the wheel 200 and outward from each opposing side of the wheel 200.

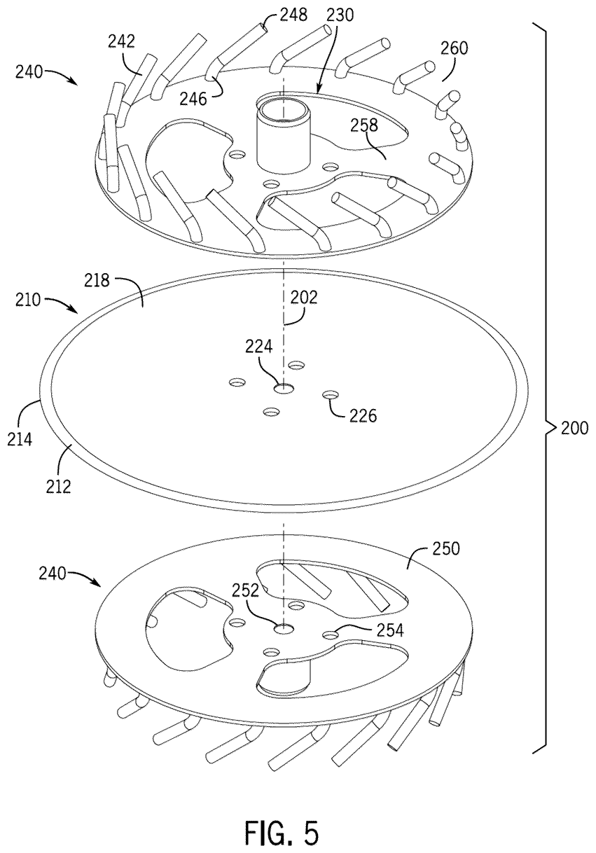

In some examples, the tread 240 optionally includes a tread cap 250. In such an example, the tread cap 250 may be an outer rim, or two or more outer rims. The tread cap 250 may be a disc, plate, annular feature, or the like having a circular or annular structure to extend about the axis of rotation 202. For example, the tread cap 250 may be an annular feature, a disc, or include spokes 258 as exemplified in FIG. 5. The tread cap 250 may define a central aperture 252 and one or more coupling apertures 254. In examples where the tread 240 includes a tread cap 250, the tread portions 242 may extend from the tread cap 250. The tread portions 242 may be positioned on the radially outer portions (e.g., along the perimeter) of the tread cap 250. The tread portions 242 and the tread cap 250 may be integrally formed or the tread portions 242 may be connected to the tread cap 250, such as by fasteners, welds, adhesives, or the like.

The tread 240, or tread portions 242a and 242b, may be formed symmetrically on opposite sides of the center plane 203, as shown in FIG. 6. In various embodiments the tread portions 242a, 242b may not be formed symmetrically on opposite sides of the center plane 203. For example, the tread portions 242a, 242b may be annularly offset about the axis of rotation 202 or positioned at different angles, lengths, or positions extending from the center plane 203.

Additionally or alternatively, tread portions 242a may be longer than tread portions 242b. Tread portions 242b may be longer than tread portions 242a. Lengths, diameters, and/or other characteristics of the tread portions 242a, 242b may alternate between sides.

Adjacent tread portions 242 on the same side of the center plane 203 may define voids 260 between each of the tread portions 242. As used herein, the voids 260 are a volume of space defined between the tread portions 242. For example, the tread portions 242 may be discretely positioned features separated by the voids 260. In other examples, the tread portions 242 may connected and a recess or aperture defined therebetween may be the voids 260. The voids 260 may be sufficiently defined such that no portion of the tread 240 contacts a field surface 80 between the tread portions 242.

As discussed above, the tread portions 242 may have a width 308, as shown in FIG. 6, between ½ and 5 inches. In some examples, the tread portions 242 may have a greater length than width due to bends or other profiles. The tread portions 242 may define a peripheral surface area 262.

The application of the wheel 200 may influence the desired length of tread portion 242. For example, depending on the soil conditions, the tread portions 242 may be positioned perpendicular to the ground 80 such that the tread portions 242 press on the ground 80 evenly and have a length sufficient to maintain the tread portions at or adjacent the top of the field surface 80. In this example, the tread portions may have a width 308 between about 2 to 5 inches. The wider tread portions 242 provide improved support against the ground by increasing the peripheral surface area 262 such that the tread portions 242 press a larger area of the ground, while maintaining the voids 260.

The tread 240 and rim 210 may be formed using any known process or material such as metals, plastics, composites, or the like. Alternatively or additionally, various materials may be cast, mold, machined, or formed by any other suitable process to form the rim 210 and tread 242.

The rim 210 and tread 240 may be connected to assemble the gauge wheel 200. At least plurality of tread portions 242 may be extend outward relative to the rim 210. The tread 240 may be arranged on the side 218 of the rim such that at least one tread portion 242 on each side 218 of the wheel 200 may be in contact with the soil 80 during rotation of the wheel 200. In examples where the tread 240 includes a tread cap 250, the tread cap 250 may be connected to one or both the sides 218 of the rim 210. The tread portions 242 may be positioned radially inward from the radial edge 214. In some examples, the first series of tread portions 242a are positioned on one side 218 of the rim 210 and the second series of tread portions 242b are positioned on an opposing side 218.

To connect the tread 250 and the rim 210, the coupling apertures 254, 226 may be aligned and selectively connected, such as by fasteners. The hub 230 may be connected to the rim 210 or tread 250, or extend at least partially through one or both of the tread 250 or rim 210. For example, the hub 230 may be positioned around the axis of rotation 202 and received in the central apertures 224, 252 or adjacent the apertures 224, 252.

The assembled wheel 200 may define a first radial distance 310 between the axis of rotation 202 and the tread portions 242. The assembled wheel 200 may define a second radial distance 212 between the tread portions 242 and the radial edge 212. In some examples, the first radial distance 310 is greater than or equal to the second radial distance 212. In other examples, the first radial distance 310 is less than the second radial distance 212. The tread width 308 may be substantially greater than the rim width 306. Accordingly, the tread surface area 262 may be substantially greater than the rim surface area 219.

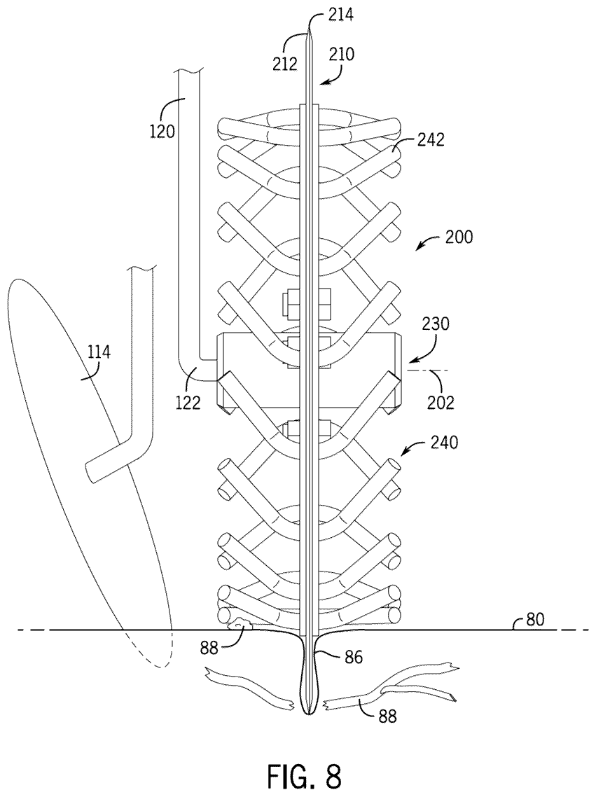

As shown in FIG. 8, the gauge wheel 200 may be supported by or connect with the arm 120 from the opener frame 108. For example, the gauge wheel 200 may receive an axle 122 and the wheel 200 may be rotatable about the axis 202. The axle 122 may rotate within hub 230. Alternatively, as discussed above, some other bracket, bearing, or similar support feature may support or connect the hub 230 and the arm 120.

FIG. 8 illustrates a front view of an embodiment of a gauge wheel 200 disposed next to or adjacent a furrow opener disc 114, or another furrow opening tool. In other examples, the gauge wheel 200 may be used with a variety of other trailing arm assembly features 100. In at least one embodiment, the gauge wheel 200 is operably connected to the furrow opener frame 108 such that the first axis of rotation 202 is generally parallel to the field surface 80. The gauge wheel 200 and opener disc 114 may be angled relative to one another.

During use, the gauge wheel 200 is positioned against the field surface 80 and sets the height 90 of the furrow opener frame 108 or trailing arm assembly 100 relative to the soil 80. As the gauge wheel 200 creates a downward pressure, the rim 210 penetrates the soil. The rim 210 may penetrate the soil 80 by the second radial distance 212 defining a seam 86. The peripheral surface area 262 of the tread 240 may be sufficient such that the tread portions 242 may remain at or adjacent the top of the soil 80. As a result, the first radial distance 210, or the position of the tread portions 242 relative to the axis of rotation 202, defines, in part, the height 90 of the frame 108 relative to the field surface.

As shown in FIG. 8, the gauge wheel 200 maintains a consistent height 90 by either, or both, breaking or cutting through debris 88 (e.g. plant matter on the soil surface, or underneath the soil surface, clumped soil, or the like) with the radial edge 214 of the rim 210, or by allowing passage of debris 88 (e.g. rocks, plant matter, or the like) through the voids 260 (spaces between the tines) defined by the tread 240.

As the gauge wheel 200 rolls, portions of the tread portions 242 progressively contact the ground, thereby rolling over the soil 80. As the outer end 248 of one tread portions 242 is lifting from the ground, at least another or adjacent tread portion 242 begins or is already in engagement with the ground. Debris 88 on top of the surface may fit within or be directed between the tread portions 242. For example, debris 88 may pass through the voids 260. As a result, the tread 240 may roll over the soil 80 while avoiding contact with debris 88 that would otherwise deflect a solid wheel feature upward, thereby changing the height 90. Further, during rotation of the tread 240, the tread portions 242 apply concentrate pressure to the soil 80, causing soil or debris 88 to be pressed towards the voids 260 between the tread portions 242. This may bias or deflect debris 88 to pass through the voids 260, rather than contacting the debris 88 and deflecting the wheel 200. The tangential and axial extension of the tread portions 242 may also assist in clearing mud or other debris 88 from the wheel 200. For example, the thin profile of the treads 242 may shed mud and the tangential orientation may be oriented vertically when the tread 240 lifts from the soil 80 such that debris 88 slips off. This may be particularly useful in wet planting conditions, or in conditions with large quantities of wrapping plant debris.

The rim 210 may break up or cut through additional debris 88 on top of or within the soil 80. Portions of the radial edge 214 cut into and rotate through the soil, extending the seam 86 as the planter moves. The radial distance from the tread 240 to the rim 210, such as for example from the tread 240 to the edge 214) may ensure the rim 210 contacts any debris along the length of the center plane 203 before the tread 240. The rim 210 may extend between about 0.25″ to about 3 inches (or more) beyond the treads 240. In other examples, the rim 210 may extend between about 0.5″ to about 2.5″, between about 1″ to about 2″, or may extend about 1.25 to 1.75″, or about 1.5″ beyond the tread 240. In another example the rim 210 may extend between about 1″ to 3″ beyond the tread 240. The extension may be constant around the rim 210, or may vary along the circumference in sawtooth, scalloped, sinusoidal, square-toothed, or other pattern. The extension of the rim 210, as defined by the edge 214, may vary consistently in the pattern, or may vary inconsistently. The longer the extension of the rim 210 beyond the treads 240, the more the rim 210 is able to contact any debris out front of the wheel and cut through it before it displaces or deflects the treads 240 to effect the furrow depth. The smaller extensions beyond the treads 240 are less able to cut through the debris ahead of the wheel. Nonetheless, the smaller and larger extends of the rim 210 may each be beneficial in certain soil types. As a result, any debris 88 that may extend across the direction of travel, or in the path of the gauge wheel 200, may be cut or broken up by the radial edge 214. As a result, the broken debris 88 may pass through the voids 260 rather than across the plane 203 and deflecting the wheel 200. A greater radial distance 212 may contact debris 88 a greater distance in advance of the tread 240, but also contact additional debris beneath the soil 80. A shorter radial distance may contact debris 88 a lesser distance in advance of the tread 240, but avoid additional debris beneath the soil 80.

Accordingly, the gauge wheel 200 of the present application assists in maintaining a consistent height 90 and limits deflection of the gauge wheel 200. For example, rolling past or breaking up the debris 88 limits deflections of the gauge wheel 200 upward, thereby improving the gauge wheels 200 control on the height 90 of the trailing arm assembly 100, and in turn furrows 106 or other operations of associated components such as seed placement, fertilizer, or the like. Accordingly, the gauge wheel 200 positively affects the furrow 106 depth and consistency, leading to improved planting and growing conditions for seeds placed into the furrows.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of' indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A gauge wheel for coupling to a trailing arm assembly of a planter, the gauge wheel comprising:
a hub rotatable about an axis of rotation;
a rim coupled to the hub and including a perimeter edge, the rim having a first side and second side opposite the first side;
a first plurality of tread portions extending from the first side and positioned radially inward from the perimeter edge; and
a second plurality of tread portions extending from the second side and positioned radially inward from the perimeter edge.

2. The gauge wheel of claim 1, wherein the first plurality of tread portions and the second plurality of tread portions are annularly aligned with each other relative to the axis of rotation.

3. The gauge wheel of claim 1, wherein the first plurality of tread portions are annularly spaced about the first side.

4. The gauge wheel of claim 1, wherein each tread portion of the first plurality of tread portions includes a tine extending from the first side in a direction that includes a directional component in one or more of a radial direction, an axial direction, or a tangential direction.

5. The gauge wheel of claim 4, wherein each tread portion of the second plurality of tread portions includes a tine extending from the first side in a direction that includes a directional component in one or more of a radial direction, the axial direction, or the tangential direction.

6. The gauge wheel of claim 1, wherein a first distance between the perimeter edge and the first plurality of tread portions is less than a second distance between the perimeter edge and the axis of rotation.

7. The gauge wheel of claim 1, wherein a first distance between the perimeter edge and the first plurality of tread portions is greater than a second distance between the perimeter edge and the axis of rotation.

8. The gauge wheel of claim 1, wherein:
the rim defines a periphery radially outward from the axis of rotation, the periphery including the perimeter edge; and
the periphery narrows in a radial direction to the perimeter edge.

9. An agricultural wheel coupled to a trailing arm assembly of a planter, the agricultural wheel comprising:
a hub rotatable about an axis of rotation;
a rim extending radially from the hub and defining a perimeter, the rim having a first side and second side opposite the first side; and
an outer rim assembly coupled to at least one of the first side or the second side and defining a radial outer portion, the outer rim assembly including a plurality of tread portions annularly spaced about the radial outer portion;
wherein:
the rim extends radially outward beyond the plurality of tread portions; and
the agricultural wheel is configured to define a position of one or more components of the trailing arm assembly relative to a field surface.

10. The agricultural wheel of claim 9, wherein:
the plurality of tread portions is a first plurality of tread portions; and
the outer rim assembly comprises:
a first outer rim coupled to the first side and including the first plurality of tread portions; and
a second outer rim coupled to the second side and including a second plurality of tread portions.

11. The agricultural wheel of claim 10, wherein:
the first plurality of tread portions extend axially in a first direction away from the rim; and
the second plurality of tread portions extend axially a second direction away from the rim.

12. The agricultural wheel of claim 10, wherein the first plurality of tread portions and the second plurality of tread portions are annularly spaced about the axis of rotation.

13. The agricultural wheel of claim 9, wherein:
the plurality of tread portions defines a peripheral surface area;
the perimeter defines a central surface area along the perimeter; and
the peripheral surface area is greater than the central surface area.

14. The agricultural wheel of claim 9, wherein:
the rim defines a major plane orthogonal to the axis of rotation; and
the agricultural wheel is symmetrical about to the major plane.

15. A gauge wheel comprising:
a hub rotatable about an axis of rotation;
a rim extending radially from the axis and defining a perimeter positioned radially outward from the hub and extending annularly about the axis of rotation; and
a plurality of tread portions annularly spaced about the axis of rotation and positioned radially inward from the perimeter;
wherein during use the plurality of tread portions are configured to be positioned on or adjacent a top surface of a field and the perimeter is configured to be positioned at least partially below the top surface.

16. The gauge wheel of claim 15, further comprising an outer rim assembly including:
a first outer rim coupled to a first side of the rim; and
a second outer rim coupled to a second side of the rim opposite the first side.

17. The gauge wheel of claim 16, wherein the outer rim assembly includes the plurality of tread portions.

18. The gauge wheel of claim 16, wherein the plurality of tread portions are integrally formed with at least one of the first outer rim or the second outer rim.

19. The gauge wheel of claim 15, wherein the plurality of tread portions are integrally formed with the rim.

20. The gauge wheel of claim 15, wherein:
the rim has an axial width;
a tread portion of the plurality of tread portions has a tread width; and
the tread width is greater than or equal to the axial width.
